(19) United States
(12) Patent Application Publication
(10) Pub. No.: US 2019/0256736 A1
(43) Pub. Date: Aug. 22, 2019

(54) UV-Curable Coating or Ink Composition

(71) Applicant: The Yenkin-Majestic Paint Corporation, Columbus, OH (US)

(72) Inventors: Edmund S. Babinski, JR., Columbus, OH (US); Andrew O. Smith, Columbus, OH (US)

(73) Assignee: The Yenkin-Majestic Paint Corporation, Columbus, OH (US)

(21) Appl. No.: 15/899,776

(22) Filed: Feb. 20, 2018

(51) Int. Cl. C09D 167/08; C09D 11/101; B05D 3/06

(52) U.S. Cl. CPC C09D 167/08; B05D 3/067; C09D 11/101

(57) ABSTRACT

A highly branched alkyd polymer based on vegetable oils and fatty acids that produces a unique UV-curable coating or ink compositions is disclosed. The z-average molecular weight of the highly branched polymer is greater than 30,000 Daltons.

### BACKGROUND

An early patent (U.S. Pat. No. 1,893,873) granted to R. H. Kienle in 1927 described a varnish-type coating made from a mixture of a polyhydric alcohol; a polybasic aromatic acid; an unsaturated, oxidizable fatty acid having more than one double bond derived from a drying oil; and a solvent. The mixture, when heated, produced a resin that could be dissolved in an organic solvent, applied to a surface, such as a metal, then cured by evaporation of solvent at room temperature.

In this type of technology, the applied varnish hardens over a period of time as the solvent evaporates and as oxidation of the resin-mixture occurs, which processes are dependent upon environmental conditions, such temperature and humidity. Thus, the time period for curing such a varnish can be very long, quite variable, and extremely inefficient. Therefore, there exists a need for an effective solution to the problem of inefficient and ineffective varnish coating compositions and processes, which the present application addresses.

### SUMMARY

The present application is directed to a UV-curable coating or ink composition comprising a UV-curable alkyd having an acrylate functionality. In one embodiment, the UV-curable alkyd is a highly branched polymer having a z-average molecular weight between 20,000-50,000 Daltons. In an exemplary composition, the UV-curable alkyd comprises 10%-90% by weight of the UV-curable coating composition and has a z-average molecular weight greater than 30,000 Daltons.

Other components can be added to the UV-curable composition in addition to the UV-curable alkyd, such as at least one reactive diluent. The reactive diluent can be chosen from TMPTA (trimethylolpropane triacrylate), HDDA (1,6-hexanediol diacrylate), DPGDA (dipropyleneglycol diacrylate), TPGDA (tripropyleneglycol diacrylate), PETA (pentaerythritol tetraacrylate), PEG(400)DA (polypropyleneglycol (400 MW) diacrylate), TMPEOTA (ethoxylated trimethylolpropane triacrylate), or mixtures thereof. The UV-curable composition can contain between 45-55% by weight of the reactive diluent.

In another embodiment, the UV-curable alkyd composition also contains at least one solvent. In yet another embodiment, the UV-curable alkyd composition further includes a colored pigment. It is to be understood however, that the UV-curable composition can have pigmented or a colorless appearance.

The UV-curable alkyd composition can further include a urethane acrylate, a polyester acrylate, an epoxy acrylate, an acrylic acrylate, an unsaturated polyester (maleic anhydride functional), a polyolefin, a polyether, an amine-modified polymer, a nitrocellulose, an alkylated cellulosic, or mixtures thereof.

In another embodiment, the UV-curable alkyd composition can also contain a photoinitiator, a chemically-assisted photoinitiator, an electron beam and thiol/ene based photoinitiator, or mixtures thereof. The photoinitiator can be chosen from benzophenone, 4-chloro-benzophenone, 1-hydroxy-cyclohexyl-phenyl ketone, 2-hydroxy-2-methyl-1-phenyl-1-propanone, methylbenzoyl formate, 4-phenyl-benzophenone, or mixtures thereof. The UV-curable composition includes between 2%-8% by weight photoinitiator.

In still another embodiment, the UV-curable alkyd composition can further include a filler, a polymeric matting agent, a deaerator, a flow agent, or mixtures thereof. In yet another embodiment, the UV-curable alkyd composition can also include an inert pigment including silica, talc, or mixtures thereof.

In an alternative embodiment, the UV-curable alkyd composition can also contain a metal oxide, an acrylated metal oxide, or mixtures thereof. The metal oxide can include aluminum oxide, cerium oxide, zinc oxide, silica oxide, and mixtures thereof. The amount of metal oxide in the composition ranges from about 2-10% by weight. The particle size of the metal oxide is in the range of about 5-150 nm.

The UV-curable composition has a viscosity of between 3,000-7000 cp at a UV-curable alkyd level between 30-75% by weight before curing. In an alternate embodiment, the UV-curable composition has a viscosity of between 4500-5500 cp at a UV-curable alkyd level between 45-55% by weight before curing.

The present application is also directed to a composition made from a highly branched, UV-curable alkyd having a z-average molecular weight greater than 30,000 Daltons; a reactive diluent; a photoinitiator; and a deaerator.

In addition, the present application discloses a process of providing a glossy or mat polymer finish on the surface of an article that includes (a) applying a UV-curable coating or ink composition comprising about 10-90% by weight of a highly branched, UV-curable alkyd having an acrylate functionality and having a z-average molecular weight greater than 30,000 Daltons to the article by spray, HVLP spray, airless/air assisted spray, rotary atomization, flowcoat, curtain coat, rollcoat, or mixtures thereof; and (b) curing the UV-curable coating composition by exposure to UV light until hardened.

The UV-curable composition of this application has several benefits and advantages. One particular benefit is an enhanced performance as compared to other coatings. For example, the highly branched and high molecular weight alkyds that are part of the compositions described herein possess excellent substrate and pigment wetting characteristics. Another benefit of the UV-curable composition is that it provides an aesthetically-pleasing gloss finish and delivers a rich distinctness of image (DOI). Still another benefit of the UV-curable composition is an improved penetration of porous substrates, such as wood. Thus, the handsome features of natural wood substrates, which are highly desirable in today's competitive market, are well-protected. Another benefit is a more effective method of hardening the coating composition, which method advantageously has a reduced curing time and more efficient curing means due to the presence of the UV-curable alkyd having an acrylate functionality.

### DETAILED DESCRIPTION

The present disclosure is directed to a UV-curable coating or ink composition based on an alkyd having an acrylate functionality, which is a highly branched polymer made from a mixture of a fatty acid, a polyhydric alcohol, and a diacid. The alkyd has z-average molecular weight (Mz) greater than 30,000 Daltons and is different from fatty-acid-modified polymers or binders made from linear or slightly branched polymer backbones having a z-average molecular weight less than 30,000 Daltons.

An exemplary UV-curable alkyd can be obtained from OPC Polymers (tradename RadKyd™), Columbus, Ohio. The RadKyd™ alkyd product contains highly branched alkyd polymers having an acrylate functionality with z-average molecular weights greater than 30,000 Daltons, as measured by a Waters Breeze 2 HPLC system (Waters Corporation) employing (4) Styragel HR #1-#4 columns. Molecular weight data was calculated using a calibration curve generated from known molecular weight Polystyrene standards. Tetrahydrofuran was used for sample dilution and as the mobile phase at a flow rate of 1.0 ml/min. Refractive Index was used as the detection mechanism. These alkyds have sufficient unsaturation to be cured by UV and EB radiation.

In the UV-curable compositions described herein, the alkyds can be compounded with a photoinitiator, a reactive diluent, a deaerator, a flow agent, and mixtures thereof.

Examples of photoinitiators include, but are not limited to benzophenone, 4-chloro benzophenone, 1-hydroxy-cyclohexyl-phenyl ketone, 2-hydroxy-2-methyl-1-phenyl-1-propanone, methylbenzoyl formate, 4-phenyl benzophenone and blends of the above compounds. In one embodiment, a blend of benzophenone and 1-hydroxy-cyclohexyl-phenyl ketone is used. The amount of photoinitiator present in the UV-curable composition ranges between 2%-8% by weight depending on cure conditions and application. In another embodiment, a range of between 3%-5% by weight photoinitiator is used in the composition.

Reactive diluents with molecular weights between 150-2,000 gram/mole can also be used in conjunction with UV-curable alkyds. The reactive diluents help to reduce viscosity, aid flow and leveling, improve flexibility, control cure speed, and adjust for desired application and film performance properties. Examples of reactive diluents include, but are not limited to, TMPTA (trimethylolpropane triacrylate), HDDA (1,6-hexanediol diacrylate), DPGDA (dipropyleneglycol diacrylate), TPGDA (tripropyleneglycol diacrylate), PETA (pentaerythritol tetraacrylate), PEG(400)DA (polypropyleneglycol (400 MW) diacrylate), and TMPEOTA (ethoxylated trimethylolpropane triacrylate). In one embodiment, the UV-curable composition incorporates between 45-55% by weight of a reactive diluent. In another embodiment, the level of a reactive diluent in the UV-curable composition is between 20-40% by weight. At least one solvent can also be used in the UV-curable alkyd composition.

UV-curable alkyds have compatibility with other chemicals typically employed in the UV coating and ink industries. Examples of these chemicals include, but are not limited to, urethane acrylate, polyester acrylate, unsaturated polyester (maleic anhydride functional), epoxy acrylate, acrylic acrylate, unsaturated polyester (maleic anhydride functional), polyolefin, polyether, amine modified polymer, nitrocellulose, various alkylated cellulosics, and mixtures thereof.

The alkyd composition can further include a filler, a polymeric matting agent, a deaerator, a flow agent, or mixtures thereof. The mattifying is typically accomplished by adding a polymeric matting agent or inert pigments, such as silica and talc, to the UV-curable composition. Due to lower vertical shrinkage of 100% solid UV coatings, matting is less efficient in 100% solid UV coatings than conventional solvent-based coatings. Alkyds assist in increasing the matting efficiency of 100% solid UV coatings due to their lower bulk density relative to typical UV oligomers used in the coatings and inks industries. Examples of commercially available matting agents include, but are not limited to, Acematt®OK 607 and Acematt® 3600 from Evonik Industries, Essen, Germany and Syloid® Rad 2005 and Syloid® Rad 2105 from W.R. Grace, Worms, Germany.

The surface hardness, scratch resistance, and mar resistance of the coating compositions disclosed herein can be modified with the addition of small particle size metal oxides and/or acrylated metal oxides. Exemplary small particle size metal oxides are aluminum oxide, cerium oxide, zinc oxide, and silica oxide. These metal oxides can either be dispersed in acrylates and/or multifunctional acrylates or chemically reacted with acrylates or multifunctional acrylates. The particle sizes for these metal oxides are in the range of 5 nm to 150 nm. The amount of metal oxides present in the UV-curable composition ranges between 2%-10% by weight. Examples of these metal oxides include, but are not limited to, NanoArc® product line from Nanophase, Inc., Romeoville, Ill. and Nanocryl® product line from Evonik Industries, Essen, Germany.

UV-curable compositions based on UV-curable alkyds can also be pigmented to produce high gloss or matte finish coatings, inks, or OPV (Over Print Varnish) films. Pigmented UV-curable coatings find applications over metal, plastic, wood, paper, and foil substrates. Pigmented UV-curable coatings based on UV-curable alkyds require more efficient photoinitiators to achieve complete cure due to UV light scattering by pigment particles. Examples of these more efficient photoinitiators include, but are not limited to, 2-benzyl-2-dimethylamino-1-(4-morpholinophenyl)-1-butanone, 2-ethylhexyl-4-dimethylaminobenzoate, isopropylthioxanthone, diphenyl (2,4,6-trimethylbenzoyl)-phosphine oxide, 2-methyl-1-[4-(methylthio)phenyl]-2-(4-morpholinyl)-1-propanone, and 2,4-diethyl thioxanthone. Typical ranges for photoinitiator level in pigmented UV-curable coatings and inks is 7-14% by weight of total UV-curable composition, depending on pigment level and dry film thickness desired. In another embodiment, 8-12% by weight of the photoinitiator is used.

The final UV-curable composition typically has a viscosity between 3,000-7,000 cP at a UV-curable alkyd level between 30-75% by weight. In another embodiment, the UV-curable coating composition has a viscosity between 4,500-5,500 cP at an UV-curable alkyd level between 45-55% by weight.

A process of providing a glossy or mat polymer finish on the surface of an article is also contemplated herein. The process includes (a) applying a UV-curable coating or ink composition comprising about 10-90% by weight of a highly branched, UV-curable alkyd having an acrylate functionality and having a z-average molecular weight greater than 30,000 Daltons to the article by spray, HVLP spray, airless/air assisted spray, rotary atomization, flowcoat, curtain coat, rollcoat, or mixtures thereof; and (b) curing the UV-curable coating composition by exposure to UV light until hardened, as described in more detail below.

UV-curable coatings compounded from UV-curable alkyds were applied to test charts, aluminum test plaques, and wood substrates by two methods. The first method involved application to the test substrate by use of a byko-drive Automatic Film Applicator (BYK-Gardner USA, 9104 Guilford Road Columbia, Md. 21046), equipped with a #10 RDS Rod from Paul N. Gardner Company, 316 NE 1st St, Pompano Beach, Fla. 33060. Substrates utilized with the first method include Leneta Form 2A-RH from The Leneta Company, 15 Whitney Rd, Mahwah, N.J. 07430; 0.025 inch×4 inch×8 inch Chromate Pretreated Aluminum panels, Model AL-48, from Q-Lab Corporation, 800 Canterbury Rd, Westlake, Ohio 44145-1419; and approximately 0.25 inch×2.25 inch×8.75 inch oak veneer panels cut from 4 ft×8 ft stock obtained from Steve Wall Lumber Company, 7800 NC Hwy. 135, Mayodan, N.C. 27027. UV-curable coating formulations were applied to Leneta Form 2A-RH with the byko-drive Automatic Film Applicator in a single pass and cured by exposure to one pass through an American Ultraviolet UV 400 watt Mini Conveyor Ultraviolet Curing Reactor (American Ultraviolet Company, 212 S. Mount Zion Road, Lebanon, Ind. 46052), equipped with a medium pressure mercury lamp (Item #A9462MCB) housed in an elliptical reflector. UV-curable coatings were cured with one pass through the unit at 21-27 FPM with the lamps set at 300 WPI. The measured cure energy ranged from 0.309-0.329 J/cm² and 0.410-0.699 W/cm². UV-curable coating formulations were applied to AL-48 and 0.25 inch oak veneer with the byko-drive Automatic Film Applicator in two passes. The first pass was cured by exposure to one pass through an American Ultraviolet UV 400 watt Mini Conveyor Ultraviolet Curing Reactor (American Ultraviolet Company, 212 S. Mount Zion Road, Lebanon, Ind. 46052), equipped with a medium pressure mercury lamp (Item #A9462MCB) housed in an elliptical reflector. UV-curable coatings were cured with one pass through the unit at 21-27 FPM with the lamps set at 300 WPI. The measured cure energy ranged from 0.309-0.329 J/cm² and 0.410-0.699 W/cm². The coated and cured panels were then sanded by sponge sanding with a 3M Softback Sanding Sponge, Grade—Super Fine, model #02602, (3M Automotive Aftermarket Division, 3M Center, Bldg. 223-6N-01, St. Paul, Minn. 55144-1000). After sanding, the panels were wiped with a soft cloth, and blown off with compressed air. A second layer of coating was then applied to the panels and cured with three passes through the UV reactor at 21-27 FPM with the lamps set at 300 WPI. The measured cure energy ranged from 0.970-0.990 J/cm² and 0.420-0.736 W/cm².

The second method of applying UV-curable coatings involved application of the UV-curable coatings in a multi-step process by application to wood substrate, typically 2.25×11 inch solid oak strip flooring sanded with 150 grit paper. The UV-curable coatings were applied to the strip flooring utilizing a Burkle Lacquer Roller Coatings Machine, Model BKL 200 from European Woodworking Machinery Co., 91 Bolk's Way, Highway 56 East, Franklinton, N.C. 27525, as follows: Approximately 8.5 gram/m² coating was applied to the wood substrate; the coating was cured by exposure to one pass through an American Ultraviolet UV 400 watt Mini Conveyor Ultraviolet Curing Reactor (American Ultraviolet Company, 212 S. Mount Zion Road, Lebanon, Ind. 46052), equipped with a medium pressure mercury lamp (Item # A9462MCB) housed in an elliptical reflector. The unit had settings of 21-27 FPM with the lamps set at 300 . The measured cure energy ranged from 0.309-0.329 J/cm² and 0.410-0.699 W/cm². In like manner, a second layer of coating having a thickness of approximately 8.5 g/m² of coating was applied and cured; then a third layer of coating having a thickness of approximately 8.5 g/m² of coatings was applied; the coated substrate was then cured with three passes through the UV reactor at 21-27 FPM with the lamps set at 300 WPI. The measured cure energy ranged from 0.970-0.990 J/cm² and 0.420-0.736 W/cm². The coated and cured panels were then sanded by sponge sanding with a 3M Softback Sanding Sponge, Grade—Super Fine, model #02602, (3M Automotive Aftermarket Division, 3M Center, Bldg. 223-6N-01, St. Paul, Minn. 55144-1000). After sanding, the panels were wiped with a soft cloth, and blown off with compressed air. Additional coating was applied to the panels as follows: Approximately 8.5 gram/m² coating was applied to the wood substrate; the coating was cured by exposure to one pass through an American Ultraviolet UV 400 watt Mini Conveyor Ultraviolet Curing Reactor (American Ultraviolet Company, 212 S. Mount Zion Road, Lebanon, Ind. 46052), equipped with a medium pressure mercury lamp (Item # A9462MCB) housed in an elliptical reflector. Coatings were cured with one pass through the unit at 21-27 FPM with the lamps set at 300 WPI. The measured cure energy ranged from 0.309-0.329 J/cm² and 0.410-0.699 W/cm². In like manner, a second coating of approximately 8.5 g/m² was applied and cured; the panel was then warmed in a 66° C. Blue M oven (model # OV-490A-3) for 60 seconds, then a third layer of coating of approximately 8.5 g/m² was applied; the coated substrate was then cured with three passes through the UV reactor at 21-27 FPM with the lamps set at 300 WPI. The measured cure energy ranged from 0.970-0.990 J/cm² and 0.420-0.736 W/cm².

### EXAMPLE 1

### Preparation of Clear UV-Curable Coating Composition with UV-Curable Alkyd

The components listed in Table 1 are combined in the order given to form a clear, UV-curable, coating composition.

TABLE 1

| Raw Material | Weight Percent |
|---|---|
| RadKyd ™ (UV-Curable Alkyd) | 85.00 |
| Tripropylene Glycol Diacrylate (reactive diluent) | 18.22 |
| Trimethylolpropane Triacrylate (reactive diluent) | 18.22 |
| Polyethylene Glycol (400) Diacrylate (reactive diluent) | 48.56 |
| Darocure ® 1173 (photoinitiator) | 5.95 |
| Airex ® 920 (deaerator) | 0.53 |
| Total | 176.48 |

### EXAMPLE 2

### Preparation of Comparative Sample #1—Urethane Acrylate

The components listed in Table (2) are combined in the order given to form a clear UV-curable coating composition.

TABLE (2)

| Raw Material | Weight Percent |
|---|---|
| Ebecryl ® 264 (UV-Curable Urethane Acrylate) | 85.00 |
| Tripropylene Glycol Diacrylate (reactive diluent) | 15.00 |
| Trimethylolpropane Triacrylate (reactive diluent) | 18.22 |
| Polyethylene Glycol (400) Diacrylate (reactive diluent) | 48.56 |
| Hexanediol Diacrylate (reactive diluent) | 3.22 |
| Darocure ® 1173 (photoinitiator) | 5.95 |
| Airex ® 920 (deaerator) | 0.53 |
| Total | 176.48 |

### EXAMPLE 3

### Preparation of Comparative Sample #2—Polyester Acrylate

The components listed in Table (3) are combined in the order given to form a clear UV-curable coating composition.

TABLE (3)

| Raw Material | Weight Percent |
|---|---|
| Laromer ® PE-55F (UV-Curable Polyester Acrylate) | 85.00 |
| Tripropylene Glycol Diacrylate (reactive diluent) | 18.22 |
| Trimethylolpropane Triacrylate (reactive diluent) | 18.22 |
| Polyethylene Glycol (400) Diacrylate (reactive diluent) | 48.56 |
| Darocure ® 1173 (photoinitiator) | 5.95 |
| Airex ® 920 (deaerator) | 0.53 |
| Total | 176.48 |

### EXAMPLE 4

### Preparation of Pigmented UV-Curable Ink Composition with UV-Curable Alkyd

The components listed in Table (4) are combined in the order given to form a pigmented UV-curable coating composition using colorants.

TABLE (4)

| Raw Material | Weight |
|---|---|
| Penn Color 9S4 (Blue pigment) | 40.00 |
| Genorad ® 16 (stabilizer) | 0.50 |
| RadKyd ™ (UV-Curable Alkyd) | 13.50 |
| Hexa-functional Urethane Acrylate (reactive diluent) | 5.00 |
| Trimethylolethane(3EO) Triacrylate (reactive diluent) | 11.00 |
| Dipropyleneglycol Diacrylate (reactive diluent) | 19.50 |
| 2-Benzyl-2-dimethylamino-1-(4-morpholinophenyl)-1-butanone | 3.80 |
| (photoinitiator) | |
| 2-Ethylhexyl-4-dimethylaminobenzoate (photoinitiator) | 2.40 |
| Isopropylthioxanthone (photoinitiator) | 0.90 |
| 4-Phenylbenzophenone (photoinitiator) | 2.40 |
| Polyfluo ® 190 (wax) | 1.00 |
| Total | 100.00 |

### EXAMPLE 5

### Comparative Pigmented UV-Curable Ink Composition with Epoxy Acrylate

The components listed in Table (5) are combined in the order given to form a pigmented UV-curable coating composition using colorants.

TABLE (5)

| Raw Material | Weight |
|---|---|
| Penn Color 9S4 (Blue pigment) | 40.00 |
| Genorad ® 16 (stabilizers) | 0.50 |
| Epoxy Acrylate (polymer) | 13.50 |
| Hexa-functional Urethane Acrylate (reactive diluent) | 5.00 |
| Trimethylolethane(3EO) Triacrylate (reactive diluent) | 11.00 |
| Dipropyleneglycol Diacrylate (reactive diluent) | 19.50 |
| 2-Benzyl-2-dimethylamino-1-(4-morpholinophenyl)-1-butanone | 3.80 |
| (photoinitiator) | |
| 2-Ethylhexyl-4-dimethylaminobenzoate (photoinitiator) | 2.40 |
| Isopropylthioxanthone (photoinitiator) | 0.90 |
| 4-Phenylbenzophenone (photoinitiator) | 2.40 |
| Polyfluo ® 190 (wax) | 1.00 |
| Total | 100.00 |

### Performance Data for UV-Curable Wood Clear Formulations

TABLE # 6
(Aesthetics and Cure Evaluation)
Films were cast with a 10RDS rod and cured at 329 mj/(cm)²
with an Irradiance of .410 Watts/(cm)²

| | UV- | | |
|---|---|---|---|
| | Curable | Polyester | Urethane |
| Property | Alkyd | Acrylate | Acrylate |
| Gloss | | | |
| 20 Degree | 87 | 56 | 71 |
| 60 Degree | 91 | 87 | 85 |
| 85 Degree | 98 | 92 | 98 |
| Clarity | 5 | 3 | 3 |
| (5 = best; 0 = | | | |
| worst) | | | |
| Pencil | H | 2H | F |
| Hardness | | | |
| Cure Response | 5 | 5 | 3 |
| @ 329 mj/ | | | |
| (cm)2 | | | |
| (5 = best; 0 = | | | |
| worst) | | | |

TABLE # 7
(Chemical/Stain Resistance Data)
Films Cured at 990 mj/(cm)² with a Dry Film
Thickness (DFT) between 2.0-3.0 mil

| | UV- | | |
|---|---|---|---|
| | curable | Polyester | Urethane |
| Property | alkyd | Acrylate | Acrylate |
| Nail Polish | 5.0 | 5.0 | 5.0 |
| 10% | | | |
| Mercurochrome | 1.0 | 1.0 | 0.5 |
| Iodine Tincture | 1.0 | 1.0 | 0.5 |
| Shoe Polish - Kiwi - | 3.5 | 2.5 | 3.3 |
| Cordovan | | | |
| Mustard | 1.0 | 1.0 | 1.0 |
| Ketchup (Harris | 5.0 | 5.0 | 5.0 |
| Teeter) | | | |
| Lipstick | 5.0 | 5.0 | 5.0 |
| Cola | 5.0 | 5.0 | 5.0 |
| Vinegar - | 4.8 | 5.0 | 5.0 |
| Whitehouse | | | |
| Distilled | | | |
| 100 Proof Alcohol | 5.0 | 5.0 | 4.8 |
| Bleach (Harris | 1.0 | 5.0 | 3.0 |
| Teeter Original | | | |
| Concentrated) | | | |
| 409 Cleaner | 5.0 | 3.0 | 2.5 |
| MEK | 5.0 | 4.8 | 5.0 |
| Water | 5.0 | 3.5 | 1.0 |
| Acetone | 5.0 | 4.5 | 0.0 |
| Total | 57.3 | 56.3 | 46.6 |

The procedure followed included applying stains and letting soak for 2 hours then cleaning with water. Solid stains, such as nail polish and shoe polish, were wiped off with a dry cloth only.
0 = very poor, destruction of sample
1 = poor
2 = fair
3 = good
4 = very slight effect

### Performance Data for UV-Curable Ink Formulations

TABLE # 8
Cure conditions: 35 FPM line speed/Energy =
137 mj/(cm)²/Irradiance = .373 Watts/(cm)²
Lamp = Gallium doped with elliptical reflector at 300 WPI

| | Epoxy | | |
|---|---|---|---|
| | Acrylate - | UV-Curable | |
| Property | Control | Alkyd | Delta E |
| Cure - MEK | | | |
| DRS | | | |
| 25% Failure | 150 | 80 | |
| 75% Failure | 400 | 500 | |
| Surface Cure | Tack Free | Tack Free | |
| Gloss | | | |
| 20 Degree | 54.4 | 49.7 | |
| 60 Degree | 90.2 | 87.3 | |
| 85 Degree | 95.2 | 97 | |
| Color | | | |
| L* | 51.78 | 52.53 | −0.75 |
| a* | −17.36 | −18.26 | 0.9 |
| b* | −40.36 | −40.13 | −0.23 |
| Hue angle | 246.73 | 245.54 | |

The above examples illustrate that the UV-curable coating or ink composition based on alkyds provides aesthetic and color depth properties to printed articles. Those skilled in the art will know that variations can be made to alter desired ink properties without departing from the spirit and scope of the invention.

We claim:

1. A UV-curable coating or ink composition comprising about 10-90% by weight of a highly branched, UV-curable alkyd having an acrylate functionality and having a z-average molecular weight greater than 30,000 Daltons.

2. The composition of claim 1 further comprising at least one reactive diluent.

3. The composition of claim 2 wherein the reactive diluent comprises TMPTA (trimethylolpropane triacrylate), HDDA (1,6 hexanediol diacrylate), DPGDA (dipropyleneglycol diacrylate), TPGDA (tripropyleneglycol diacrylate), PETA (pentaerythritol tetraacrylate), PEG(400)DA (polypropyleneglycol (400 MW) diacrylate), TMPEOTA (ethoxylated trimethylolpropane triacrylate), or mixtures thereof.

4. The composition of claim 2 comprising between 45-55% by weight reactive diluent.

5. The composition of claim 1 further comprising at least one solvent.

6. The composition of claim 1 further comprising at least one colored pigment.

7. The composition of claim 1 further comprising a urethane acrylate, a polyester acrylate, an epoxy acrylate, an acrylic acrylate, an unsaturated polyester (maleic anhydride functional), a polyolefin, a polyether, an amine-modified polymer, a nitrocellulose, an alkylated cellulosic, or mixtures thereof.

8. The composition of claim 1 further comprising a photoinitiator, a chemically-assisted photoinitiator, an electron beam and thiol/ene based photoinitiator, or mixtures thereof.

9. The composition of claim 8 wherein the photoinitiator comprises benzophenone, 4-chloro-benzophenone, 1-hydroxy-cyclohexyl-phenyl ketone, 2-hydroxy-2-methyl-1-phenyl-1-propanone, methylbenzoyl formate, 4-phenyl-benzophenone, or mixtures thereof.

10. The composition of claim 8 comprising between 2%-8% by weight photoinitiator.

11. The composition of claim 1 further comprising a filler, a polymeric matting agent, a deaerator, a flow agent, or mixtures thereof.

12. The composition of claim 1 comprising a viscosity of between 3,000-7000 cp at a UV-curable alkyd level between 30-75% by weight before curing.

13. The composition of claim 1 comprising a viscosity of between 4500-5500 cp at a UV-curable alkyd level between 45-55% by weight before curing.

14. The composition of claim 1 further comprising an inert pigment including silica, talc, or mixtures thereof.

15. The composition of claim 1 further comprising a metal oxide, an acrylated metal oxide, or mixtures thereof.

16. The composition of claim 15 wherein the metal oxide comprises aluminum oxide, cerium oxide, zinc oxide, silica oxide, and mixtures thereof.

17. The composition of claim 15 wherein the composition comprises about 2-10% by weight metal oxide.

18. The composition of claim 15 wherein the particle size of the metal oxides comprises about 5-150 nm.

19. A composition comprising a highly branched, UV-curable alkyd having a z-average molecular weight greater than 30,000 Daltons; a reactive diluent; a photoinitiator; and a deaerator.

20. A process of providing a glossy or mat polymer finish on the surface of an article comprising:
(a) applying a UV-curable coating or ink composition comprising about 10-90% by weight of a highly branched, UV-curable alkyd having an acrylate functionality and having a z-average molecular weight greater than 30,000 Daltons to the article by spray, HVLP spray, airless/air assisted spray, rotary atomization, flowcoat, curtain coat, rollcoat, or mixtures thereof; and
(b) curing the UV-curable coating composition by exposure to UV light until hardened.
